(19) United States
(12) Patent Application Publication
(10) Pub. No.: US 2024/0129073 A1
(43) Pub. Date: Apr. 18, 2024

(54) UPLINK ADAPTIVE FLOW CONTROL WITH PADDING MITIGATION

(71) Applicant: GOOGLE LLC, Mountain View, CA (US)

(72) Inventors: WeiChih Liao, New Taipei City (TW); Todd Ou, San Jose, CA (US); Yu Wang, Fremont, CA (US)

(21) Appl. No.: 18/495,301

(22) Filed: Oct. 26, 2023

Related U.S. Application Data
(63) Continuation of application No. PCT/US2022/046829, filed on Oct. 17, 2022.

(51) Int. Cl. H04L 1/1867; H04L 1/00

(52) U.S. Cl. CPC H04L 1/1887; H04L 1/0008

(57) ABSTRACT

A first wireless device employs an uplink (UL) pre-transmission process to temporarily buffer data for processing prior to transmission of the resulting processed data to a second wireless device. To mitigate excessive delay of higher-priority data, higher-priority data is enqueued into the UL pre-transmission process without restriction (subject to capacity limitations), while lower-priority data is selectively enqueued into the UL pre-transmission process based on one or more criteria applied to a current volume of data in the input queue. Further, the first wireless device monitors the current transmission efficiency based on, for example, the current usage of transmission padding, and operates to dynamically adjust one or more of the criteria based on the monitored current transmission efficiency.

### BACKGROUND

Cellular telephones and other user equipment (UE) typically communicate with a cellular network using concurrent bi-directional data traffic, including the transmission of uplink (UL) data to the cellular network and receipt of downlink (DL) data from the cellular network. The transmission of UL data from UE to cellular network can involve various real-time transmission pre-processing, such as ciphering of UL data before transmission. The resulting pre-processed UL data is then provided to a radio frequency (RF) transceiver for RF transmission.

Typically, UL data is pre-processed for transmission in the order in which it is enqueued. However, the UL data may be composed of data of different transmission priorities, and under the first-in first-out (FIFO) transmission approach, a significant amount of buffered lower-priority UL data can excessively delay later-enqueued higher-priority UL data, which can impact one or both of the UL throughput or the DL throughput. For example, audio data or video data of an UL multimedia stream may be prioritized and thus may be unnecessarily delayed when there is a significant amount of enqueued UL data of lower priority awaiting pre-processing and transmission. As another example, when the UE receives a Transmission Control Protocol (TCP) DL packet from the cellular network, TCP typically requires that the UE transmit a TCP Acknowledge (TCP-ACK) UL packet back to the cellular network to confirm receipt of the TCP DL packet. Some cellular standards, such as Third Generation Partnership Project (3GPP) Fifth Generation New Radio (5G NR), introduce certain procedures, such as a mini-slot concept, which result in a relatively short Transmission Time Interval. With a relatively short Transmission Time Interval, the UE may not be able to successfully transmit a TCP-ACK UL packet in time in the presence of a significant amount of previously-enqueued UL data, which would result in the cellular network having to retransmit the same DL TCP packet again in response to failure to receive a TCP-ACK UL packet within the Transmission Time Interval, and thus negatively impact both DL and UL data throughput.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a block diagram of an example cellular telephony system employing a user equipment (UE) utilizing a dynamically adjustable low-priority input buffer for uplink (UL) pre-transmission processing, in accordance with some embodiments.

FIG. 2 shows an example hardware implementation of the UE shown in FIG. 1, in accordance with some embodiments.

FIG. 3 illustrates an example detailed view of a dynamically adjustable selective enqueuing scheme for the UE shown in FIGS. 1 and 2, in accordance with some embodiments.

FIG. 4 illustrates a flowchart for an example method of implementing UL adaptive flow control for an input buffer for UL pre-transmission processing, in accordance with some embodiments.

### DETAILED DESCRIPTION

Certain protocols in the cellular protocol stack of a wireless device provide for pre-processing of UL data prior to its transmission. For example, the Packet Data Convergence Protocol (PDCP) provides for pre-transmission processing in the form of header compression processes, enciphering processes, and data integrity processes. Such protocols may employ a FIFO-type input queue to buffer UL data to be subjected to such pre-transmission processes. The protocol layer pulls UL data from this input queue, performs one or more pre-transmission processes, and forwards the resulting processed UL data to the next protocol layer in the protocol stack, ultimately leading to transmission of the processed UL data. As noted, the FIFO nature of this input queue can result in an unacceptable delay in the processing and transmission of certain UL data, due to its priority or otherwise due to a quality-of-service (QoS) requirement or other timing requirement placed on the particular UL data. Not only does the input queue introduce prioritization and delay issues in the presence of too much enqueued UL data, but the input queue is also subject to issues in the event of too little enqueued UL data. To illustrate, the cellular network typically grants the wireless component network UL transmission resources such that the wireless component must fully utilize the granted network resources or otherwise be subjected to a reduced future network resources grant. As such, should the input queue run out of UL data, the protocol stack is incentivized to employ padding to increase the amount of transmitted data to ensure that the granted UL resources are fully utilized. For example, if the UL data is insufficient to complete a transport block (TB), null padding “data” (transmission padding) will be added to the UL data to complete a transport block. While this maintains the UL resources grant, it results in inefficient UL transmission due to the transmission of padding data. Thus, the input queue for a pre-transmission process can introduce unacceptable delay in higher-priority UL data transmission in the presence of substantial enqueued UL data or introduce excessive transmission inefficiency in the absence of sufficient enqueued UL data.

To provide suitable balance between the risks of higher-priority data transmission delay and transmission inefficiency, disclosed herein are systems and techniques for adaptive flow control for pre-transmission processing via an input queue that employs one or more criteria for control of enqueuing of input data. In at least one embodiment, a modem employs a protocol stack with at least one protocol layer that implements one or more pre-transmission processes for data. These one or more pre-transmission processes are fed by a FIFO input queue that receives data of different priorities. In at least one embodiment, data with a higher priority is generally enqueued in the input queue without restriction, whereas data with a lower priority is enqueued in the input queue selectively based on one or more criteria. In implementations, these one or more criteria include application of one or more thresholds to the current amount of data in the input queue, such as an upper, or maximum, threshold (denoted “V_{HIGH}”) or a lower, or minimum, threshold (denoted “V_{LOW}”), or both the maximum threshold V_{HIGH} and the minimum threshold V_{LOW}. For example, using these particular criteria, when the amount, or volume of data in the input queue falls to the lower threshold V_{LOW}, the flow control process initiates enqueuing of low-priority data. However, if and when the volume of data in the input queue rises to the upper threshold V_{HIGH}, the flow control process prevents any further enqueuing of lower-priority data into the input queue. Thereafter, should the volume of data in the input queue fall back to the lower threshold V_{LOW}, enqueuing of low-priority data is again initiated, and so on. To facilitate this selective enqueuing of the low-priority data based on one or more criteria, the flow control process may employ another queue, identified herein as the low-priority queue, to buffer low-priority data while enqueuing of low-priority data into the input queue is blocked, so as to mitigate the risk of loss of the low-priority data.

Further, in at least one embodiment, the one or more implemented criteria are dynamically adjustable to provide for tuning of the balance between risk of higher-priority UL data delay and excessive transmission padding. To illustrate, using the thresholds V_{HIGH} and V_{LOW} as the selective enquiring criteria as an example, the lower threshold V_{LOW} set too low for the present transmission conditions risks excessive transmission padding as the input queue is more likely to be depleted and thus require the use of data padding, while being set too high for the present transmission conditions risks excessive enqueuing of low-priority data relative to enqueued high-priority data and thus increases the risk of unacceptable higher-priority UL data transmission delay. Similarly, setting the upper threshold V_{HIGH} too low would result in more aggressive blocking of low-priority data with the attendant excessive data padding risks, and setting this threshold too high likewise can result in higher-priority data transmission delay risks. Accordingly, in at least one embodiment, the wireless component characterizes the current transmission environment through monitoring of the use of padding in UL transmission, and dynamically adjusts one or both of the upper threshold or the lower threshold based on the monitored padding use. This same, or similar, approach may be utilized to dynamically adjust other criteria used for selective enqueuing of low-priority data into the input queue using the guidelines provided herein.

For ease of description and illustration, the adaptive flow rate control techniques for balancing higher-priority data transmission and transmission efficiency are described herein with reference to application of such techniques in a UE for uplink (UL) data transmissions. However, this context is for illustrative purposes only, and the techniques described herein are not limited to UL transmissions only. Rather, the same or similar principles may be similarly applied at a base station or other edge network component for downlink (DL) transmissions to a UE, to another base station, or other wireless component. Thus, reference herein to a UE employing the described techniques should be understood to apply similarly to other wireless devices, such as base stations, using the guidelines provided herein.

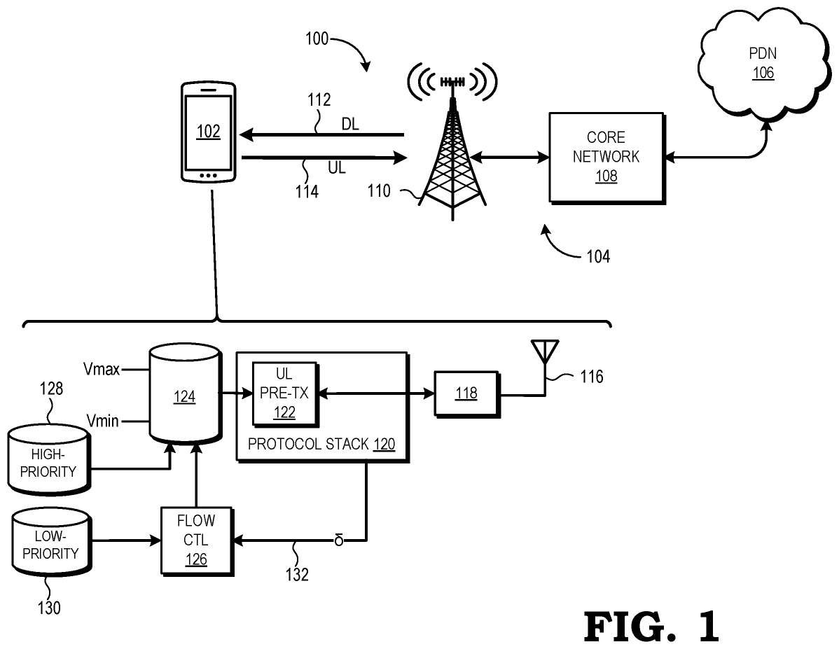

FIG. 1 illustrates an example cellular communications system 100 employing a UE 102 utilizing prioritized enqueuing of UL data for pre-transmission processing based on dynamically adjustable criteria in accordance with some embodiments. As shown, the system 100 includes a UE 102 in wireless communication with a cellular infrastructure network 104, such as a 4G LTE infrastructure network, a 5G NR infrastructure network, and the like. The UE 102 can include any of a variety of electronic wireless communication devices, such as a cellular phone, a cellular-enabled tablet computer or cellular-enabled notebook computer, a cellular-enabled watch or other wearable device, an automobile or other vehicle employing cellular services (e.g., for navigation, provision of entertainment services, in-vehicle mobile hotspots, etc.), a cellular access point (or “hot spot), and the like. The cellular infrastructure network 104 is connected to other networks, such as one or more other cellular infrastructure networks 104, via at least one packet data network (PDN) 106, such as the Internet, via one or more private interconnecting data networks, or a combination thereof.

The cellular infrastructure network 104 includes a core network 108 and a plurality of edge networks, or radio access networks (RANs), connected via a backhaul infrastructure. Although cellular infrastructure network 104 is illustrated as having core network 108, in other embodiments multiple cellular infrastructure networks 104 can share the same core network 108 and differ instead by the edge network connected to the shared core network 108. Each edge network includes at least one base station (BS) 110 operable to wirelessly communicate with UEs within signal range based on one or more radio access technologies (RATs). Examples of the base station 110 include, for example, a NodeB (or base transceiver station (BTS)) for a Universal Mobile Telecommunications System (UMTS) RAT implementation (also known as “3G”), an enhanced NodeB (eNodeB) for a 4G LTE RAT implementation, a 5G Node B (gNB) for a 5G NR RAT implementation, and the like. As is well known in the art, the base stations 110 operate as an “air interface” to establish radio frequency (RF) wireless connections with UEs (such as UE 102), and these wireless connections (or “links”) then serve as data and voice paths between the UEs and the core networks 108 for providing various services to the UEs, including voice services via circuit-switched networks or packet-switched networks, messaging services such as simple messaging service (SMS) or multimedia messaging service (MMS), multimedia content delivery, presence services, and the like. For ease of illustration, the base station 110 is described in various scenarios below as a 5G NR radio access network (RAN), and thus is an eNodeB in such scenarios, while the base station 110 is in various other scenarios a 4G LTE RAN, and thus is a gNB in such scenarios. However, it will be appreciated that the base station 110 is not limited to these example configurations. For example, the base station 110 could be a 3G RAN (e.g., a NodeB).

As a general operational overview, the UE 102 and the base station 110 cooperate to provide for transmission and receipt of RF signaling representative of a bi-directional data flow, including RF signaling representing DL data transmission 112 from the base station 110 to the UE 102 and RF signaling representing UL data transmission 114 from the UE 102 to the BS 110. For DL data transmission 112, DL RF signaling is received at the UE 102 via an RF antenna 116 and an RF transceiver 118, and the resulting digital output representing DL data is processed by one or more protocol layers of a protocol stack 120 of a cellular modem (not shown in FIG. 1) of the UE 102. Conversely, for the transmission of UL data, the UL data is provided from one or more application processors (APs) or other components to the modem, whereupon one or more protocol layers protocol stack 120 performs one or more UL pre-transmission processes on the UL data in preparation for its transmission. The resulting digital output is provided to the RF transceiver 118 and converted to wireless signaling transmitted to the BS 110 via the RF antenna 116.

Due to various factors, such as scheduling and resource availability, certain UL pre-transmission processes may employ an input queue to buffer UL data awaiting further processing. To illustrate, a UL pre-transmission process 122 implemented by a protocol layer of the protocol stack 120 may employ an input queue 124 to buffer incoming data to be processed by the UL pre-transmission process 122. For example, the UL pre-transmission process 122 may represent one or more of the header compression, ciphering, or data integrity processes performed by a PDCP layer in the protocol stack 120. The input queue 124 typically is operated as a FIFO queue such that the first data enqueued in the input queue 124 is the first data dequeued to the UL pre-transmission process 122. However, the UL data provided to the protocol stack 120 in preparation for UL transmission typically have different transmission priorities. For example, certain UL data packets that are used to characterize the current transmission environment (e.g., Internet Control Message Protocol (ICMP) packets or Domain Name Service (DNS) packets), UL data subject to QoS requirements (e.g., multimedia data streams), or UL data subject to a narrow transmission window (e.g., TCK-ACK packets) may be considered to have a higher priority (and thus, “high-priority” data) than other types of UL data, such as normal TCP/UDP UL data for non-real-time traffic(and thus, “low-priority”, or “normal”, UL data). Thus, as noted above, the processing and transmission of high-priority UL data may be unacceptably delayed in the event that there is a substantial amount of UL data already enqueued in the input queue ahead of the high-priority data.

Accordingly, in at least one embodiment the UE employs an adaptive flow control process for opportunistic management of the enqueuing of UL data into the input queue 124 of one or more UL pre-transmission processes 122 of the protocol stack 120. Further, in at least one embodiment, a queueing structure for the UL pre-transmission process 122 can include a multiple-level queue structure, such as the input queue 124 having an output to provide enqueued UL data to the UL pre-transmission process 122, as well as two lower-level queues, identified as high-priority queue 128 and low-priority queue 130, to temporarily buffer the high-priority UL data and low-priority UL data, respectively, before it is enqueued into the input queue 124.

In this process, UL data identified as higher priority (high-priority UL data) is permitted to enqueue into the input queue 124 from the high-priority queue 128 (or directly from the source AP or other source component) as it becomes available for enqueuing (queue capacity permitting). However, to achieve a more favorable balance between the risk of excessive delay of high-priority UL data and the risk of inefficient UL data throughput due to excessive padding as a result of queue underflow, the UE employs a flow control module 126 to selectively permit low-priority UL data to be enqueued from the low-priority queue 130 into the input queue 124 based on one or more criteria. Such criteria may be based on, for example, the current fullness (that is, the current enqueued data volume) of the input queue 124. For example, one or more criteria may represent the current volume of data in the input queue 124 meeting, or not meeting, a corresponding fullness threshold. In implementations, such criteria relate to one or both of an upper, or maximum, threshold (denoted “V_{HIGH}”) and a lower, or minimum, threshold (denoted “V_{LOW}”).

For these example threshold criteria, the selective enqueuing of low-priority data includes the flow control module 126 initiating the enqueuing of low-priority data when the fullness of the input queue 124 falls to lower threshold V_{LOW} (that is, when the data volume falls to meet a lower threshold), while the flow control module 126 prevents any further enqueuing of low-priority data when the fullness of the input queue 124 reaches (that is, is at or above) the upper threshold V_{HIGH} (that is, when the data volume rises to meet an upper threshold criterium). Thereafter, as data, both low-priority and high-priority, is dequeued from the input queue 124, the fullness of the input queue 124 may again fall to the lower threshold V_{LOW}, in response to which the flow control module 126 resumes enqueuing of low-priority data, and so on. Note that although the flow control module 126 is depicted as being external to the protocol stack 120 for ease of illustration, in implementation the flow control module 126 typically is a software component of the protocol layer implementing the UL pre-transmission process 122.

In processing UL data for transmission, one or more protocol layers of the protocol stack 120 may employ data padding to ensure full utilization of the granted network resources. Thus, if the input queue 124 underflows, either the UL pre-transmission process 122 or another pre-transmission process downstream in the protocol stack 120 will compensate for the underflow by padding the incomplete transport block or other transmission data unit with padding (that is, null data). As explained above, this padding is not actionable data at the receiving end, and thus the presence of padding represents a lost opportunity to transmit actual UL data.

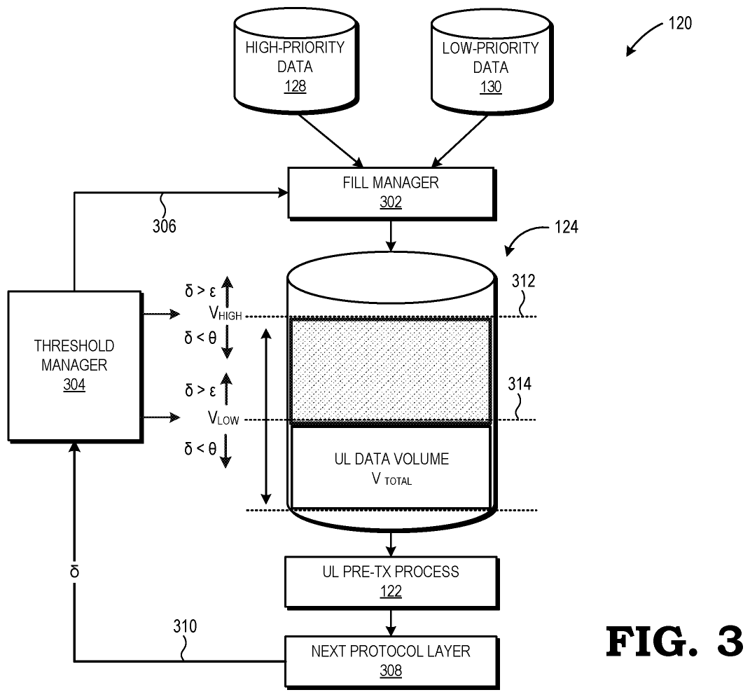

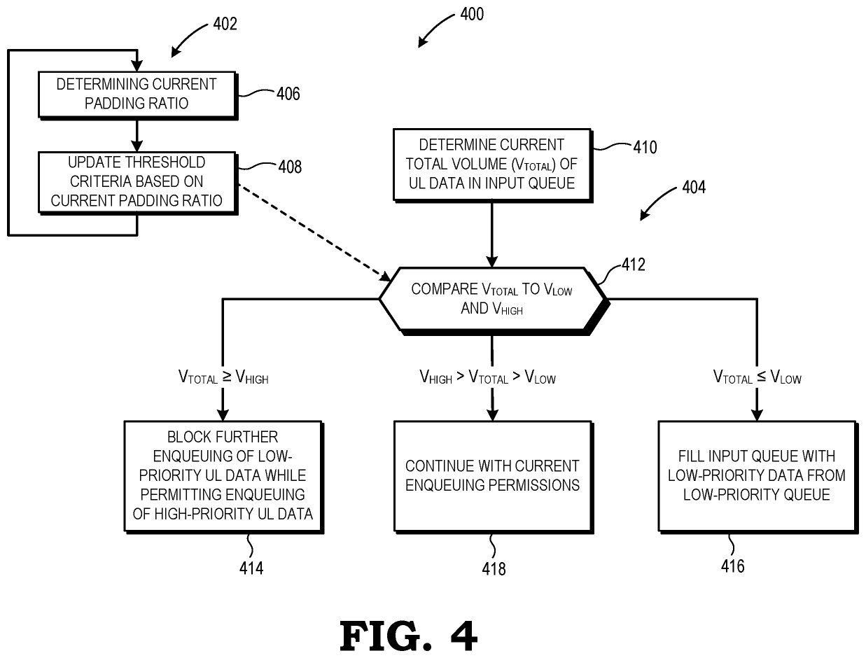

Thus, as transmission conditions may change, and as the settings for V_{HIGH} and V_{LOW} impact the balance between high-priority UL transmission delay risk and inefficient UL transmission risk, in at least one embodiment, the flow control module 126 dynamically adjusts one or both of these thresholds to provide for tuning of the balance between risk of higher-priority UL data delay and excessive UL transmission padding, or if other criteria are used, dynamically adjusts one or more other criteria in a similar manner. To illustrate, a lower threshold V_{LOW} set too low for the present transmission conditions risks excessive UL transmission padding, while being set too high for the present transmission conditions increases the risk of unacceptable higher-priority UL data transmission delay. Similarly, setting the upper threshold V_{HIGH} likewise may cause an increase in the instances of queue underflow and thus increased risk of excessive UL transmission padding, and setting this threshold too high can result in higher-priority UL data delay risks as a greater overall amount of low-priority data would be permitted to be enqueued in the input queue 124. Accordingly, in at least one embodiment, the flow control module 126 characterizes the current UL transmission environment through monitoring of the use of padding in the UL transmission (represented by padding ratio signal 132 or “6”), and dynamically adjusts one or both of the upper threshold or the lower threshold based on the monitored padding use. The processes of monitoring the current padding usage and dynamically adjusting one or more criteria, such as dynamically adjusting one or both of V_{HIGH} or V_{LOW}, for the input queue 124 accordingly is described in greater detail below with reference to FIGS. 3 and 4 below.

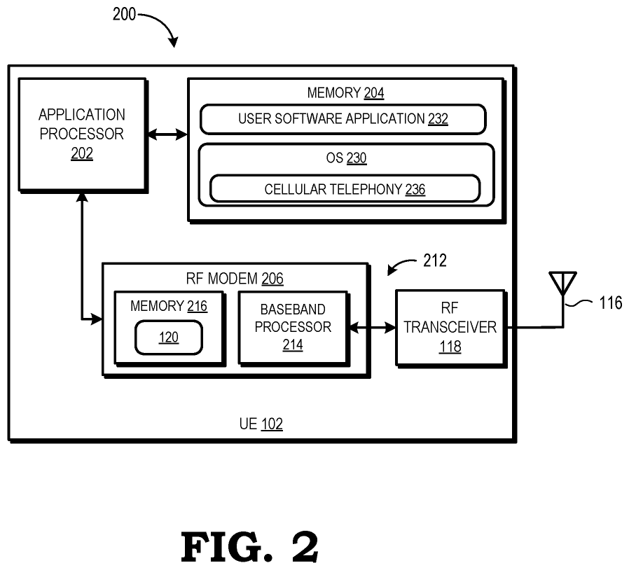

FIG. 2 illustrates an example hardware implementation 200 of the UE 102 shown in FIG. 1, in accordance with some embodiments. In the depicted example, the UE 102 includes at least one application processor 202 (e.g., a central processing unit (CPU) or other general processor), a system memory 204, one or more RF modems 206, one or more RF transceivers 118, and one or more RF antennas 116 suitable for RF signaling and signal processing in one or more frequency bands typically associated with a corresponding RAT (e.g., a 5G NR RAT). In the illustrated embodiment, the UE 102 supports one RAT 212, although multiple RATs are possible, such as supporting more than two or more RATs 212. The RF modem 206 includes a baseband processor 214 and a memory 216, which can include, for example, a Flash memory, non-volatile random-access memory (NVRAM) or other non-volatile memory, or static RAM (SRAM) or dynamic RAM (DRAM) or other volatile memory, or a combination thereof. Further, it will be appreciated that the UE 102 can include a number of additional components omitted from FIG. 2 for ease of illustration including, for example, one or more displays, one or more touchscreens, keypads, mice, touchpads, microphones, speakers, and other user input/output devices, one or more sensors, batteries or other power sources, graphical processing units (GPUs) or other coprocessors, and the like.

The application processor 202 executes executable instructions from a software stack that includes an operating system (OS) 230 and one or more user software applications, such as user software application 232, and which further can include protocol stacks executed by the baseband processor 214 of the RF modem(s) 206. The OS 230, through manipulation of the application processor 202, manages the general operation of the various hardware components of the UE 102 as well as supports the execution of the one or more user software applications, with the executable instructions representing the OS 230 and the user software application typically accessed from system memory 204 for execution by the application processor 202.

The modules of the OS 230 thus include a cellular telephony module 236 for controlling or facilitating the higher-level cellular-related operations of the UE 102, including subscriber identity management, initiation, control, and tear-down of cellular connections (including SIP messaging and RRC messaging), authentication, interfacing between cellular connections and the user software applications, and the like. Further, the memory 216 of the RF modem 206 stores one or more protocol stacks for a corresponding cellular standard, including the protocol stack 120 of FIG. 1. Each protocol stack stores executable instructions that, when executed by the baseband processor 214, manipulate the baseband processor 214 to perform various operations in accordance with a RAT protocol or other communication protocol associated with the air interface provided by the base station 110 (FIG. 1) of the cellular infrastructure network 104 for which the UE 102 is attempting to establish a communication link. As is well known, such operations typically are associated with the lower-level layers of a network protocol, such as some or all of the physical, data link, and network layers, while the OS 230 and the user software applications support the higher-level layers of the network protocol, such as the transport, session, presentation, and application layers.

As explained with reference to FIG. 1, the protocol stack 120 includes at least one protocol layer (e.g., PDCP) that employs at least one UL pre-transmission process 122 that utilizes a queue structure and a flow control module 126 to adaptively manage the enqueuing of UL data into an input queue 124 based on priority and one or more fullness thresholds for the input queue 124. As such, one or more queues of the queue structure may be implemented in system memory 204, in the memory 216 of the RF modem 206, or a combination thereof.

FIG. 3 illustrates an example detailed view of the adaptive flow approach utilized for the UL pre-transmission process 122 of the protocol stack 120 in accordance with some embodiments. As shown, the input queue 124 includes an input for receiving and enqueuing UL data and an output for dequeuing UL data to the UL pre-transmission process 122. In the depicted embodiment, the flow control module 126 is implemented as a fill manager 302 and a threshold manager 304. The fill manager 302 includes inputs connected to the high-priority queue 128 and the low-priority queue 130, and an output connected to the input of the UL pre-transmission process 122, and is operational to provide high-priority UL data available for enqueuing to the UL pre-transmission process 122 without particular restriction (other than available queue capacity) and to selectively provide low-priority UL data from the low-priority queue 130 based on control signaling 306 from the threshold manager 304. The threshold manager 304, in turn, operates to monitor the current efficiency of UL transmission by monitoring the current padding rate being employed by the protocol stack 120 downstream of the UL pre-transmission process 122 (e.g., the padding being employed by the next protocol layer 308 in the protocol stack 120).

In at least one embodiment, the current padding rate is represented by a padding ratio (δ) 310 (one embodiment of padding ratio signal 132, FIG. 1), which represents a ratio of UL data to transmitted padding used to fill a network allocated UL transport block. For example, if the network allocates a UL transport block with 10,000 bytes to the UE, and there are 8,000 bytes UL data to transmit, then 8,000 bytes are packed for the transport block transmission and 10,000−8,000=2,000 bytes are filled with padding. The padding ratio is thus (2,000/10,000)×100%=20%. Based on the padding ratio 310, the threshold manager 304 adjusts one or both of the upper threshold V_{HIGH} (threshold 312) or the lower threshold V_{LOW} (threshold 314). The threshold manager 304 further monitors the total volume (V_{TOTAL}) of UL data currently enqueued in the input queue 124, compares the total volume V_{TOTAL} with the threshold V_{HIGH}, V_{LOW}, and directs the fill manager 302 to selectively permit enqueuing of low-priority UL data based on these comparisons.

FIG. 4 illustrates an example method 400 of operation of the flow control module 126 and the input queue structure of FIG. 3 for adaptive input enqueuing of UL data for transmission pre-processing based on priority, queue fullness, and current UL transmission efficiency in accordance with some embodiments. In the depicted implementation, the method 400 includes two concurrently-executing sub-processes: a threshold adaptation sub-process 402 that operates to monitor the current padding status of the UL transmission and adjust the thresholds V_{HIGH} and V_{LOW} for the input queue 124 accordingly; and a selective enqueuing sub-process 404 that operates to monitor the current fullness of the input queue 124 relative to the thresholds V_{HIGH} and V_{LOW}, and to selectively enqueue low-priority UL data accordingly.

As explained above, setting V_{LOW} too high or V_{HIGH} too low for the current transmission conditions risks frequent underflow for the input queue 124, and thus triggering the frequent use of data padding as a result of actual data being unavailable from the input queue 124 for transmission. However, setting V_{LOW} WO low or V_{HIGH} too high for the current transmission conditions risks enqueuing more low-priority data ahead of high-priority data, and thus risking an excessive delay in the dequeuing and transmission of the high-priority data from the input queue 124. Thus, with the threshold adaptation sub-process 402, the threshold manager 304 seeks to determine suitable values for the criteria represented by V_{LOW} and V_{HIGH} that balance efficient loading of the transport blocks and the timely communication of high-priority data. Thus, at block 406, the threshold manager 304 determines the current padding ratio δ (e.g., padding ratio 310, FIG. 3) being employed in the UL transport blocks being transmitted by the UE 102. As noted above, in some embodiments the padding ratio for a transport block represents the ratio of the number of padding bytes to the total number of bytes in the transport block. Thus, the threshold manager 304 may determine the current padding ratio δ based on an analysis of the padding ratio of one or more transport blocks recently transmitted by the UE 102. For example, in some instances, the padding ratio of the most recently transmitted transport block may be set as the current padding ratio O. However, this may introduce significant jitter in the current padding ratio δ, so in other embodiments the current padding ratio δ may be determined as an average (such as a straight average or weighted average) or other statistical representation of the padding ratios of the N most recently transmitted transport blocks (N>=2).

At block 408, the threshold manager 304 uses the current padding ratio δ determined at block 406 to update one or both of the threshold criteria (e.g., thresholds V Low or V_{HIGH}) In some embodiments, the threshold manager 304 employs an algorithm based on certain predetermined factors, such as an expected padding ratio ε (that is, a padding ratio that is selected as a target padding ratio), a minimum padding ratio threshold θ (which is selected to indicate that insufficient data is being maintained in the input queue 124), and the aforementioned current padding ratio δ. In other embodiments, a preset amount in the form of a smoothing delta Δ also can be specified to facilitate incremental increases and decreases in the threshold criteria so as to smooth out any rapid changes.

As an example, V_{LOW} can be dynamically calculated using the expressions:

V_{LOW}(t+1)=UL_TP(t+1)×T_{LOW}(t+1) and

V_{HIGH}(t+1)=k*V_{LOW}(t+1)

where:
t is the current time period and t+1 is the next time period;
UL_TP( ) is the current actual or estimated UL throughput rate is determined from the physical link (PHY) layer (such as how many UL resources are received per second) in terms of bytes/millisecond (ms);
T_{LOW}( ) is an indication of the amount of data to retain in the input queue 124 in terms of time (e.g., milliseconds) at the current UL TP rate; and
k is a constant scaling factor (e.g., 1.5) that can be determined from experimentation, modeling, estimation, and the like.

To set initial values for V_{LOW} and V HIGH (that is, V_{LOW}(0) and V HIGH (0) at time t=0), T_{LOW}(0) can be set to, for example, 1-2 ms to ensure sufficient data enqueuing to avoid excessive padding at the outset.

Thereafter, the value of T_{LOW}(t+1) can be set based on a comparison of the current padding ratio δ to the expected, or target, padding ratio ε and minimum padding ratio threshold θ as follows:
If δ>ε, set T_{LOW}(t+1)=T_{LOW}(t)+Δ;
If δ<θ, set T_{LOW}(t+1)=T_{LOW}(t)−Δ; and
If θ≤δ≤ε, set T_{LOW}(t+1)=T_{LOW}(t);
and from the value T_{LOW}(t+1), the values for V_{LOW}(t+1) and V HIGH (t+1) can be updated (with upper and lower bounds being applicable to each of these thresholds).

Concurrent with the threshold manager 304 dynamically updating the threshold criteria in sub-process 402, at sub-process 404 the fill manager 302 is managing the enqueuing of data into the input queue 124. As explained above, the fill manager 302 permits high-priority data to be enqueued without regard to the threshold criteria, with the only limitation on enqueuing the high-priority data being the current inability for the input queue 124 to store any more data (that is, the input queue 124 is full). However, the fill manager 302 implements selective enqueuing of low-priority data based on the threshold criteria.

Accordingly, at block 410, the fill manager 302 determines the total volume (or amount) V_{TOTAL} of data, both high-priority and low-priority, enqueued in the input queue 124. At block 412, this total volume of data V_{TOTAL} is compared to one or both of the threshold criteria V_{LOW} and V_{HIGH} In at least one embodiment, the fill manager 302 employs a hysteresis-type approach to control the enqueuing of low-priority data. In this approach, as represented by block 414, the fill manager 302 temporarily prevents any further enqueuing of low-priority data once the total volume V_{TOTAL} meets the threshold V_{HIGH} (that is, V_{TOTAL}≥V_{HIGH}) and, as represented by block 416, the fill manager 302 subsequently permits enqueuing of low-priority data to resume once the total volume of data V_{TOTAL} has fallen to meet the threshold V_{LOW} (that is, V_{TOTAL}<V_{LOW}). As represented by block 418, when V_{TOTAL} is between V_{LOW} and V_{HIGH} (that is V_{LOW}<V_{TOTAL}<V_{HIGH}), then the fill manager 302 continues with whatever enqueuing permission state is current in place for the low-priority data. Thus, if the fill manager 302 resumed enqueuing of low-priority data once V_{TOTAL} fell to V_{LOW} (block 414), then the fill manager 302 continues to permit enqueuing of low-priority data (block 418) until V_{TOTAL} meets V_{HIGH}, at which point the fill manager 302 ceases enqueuing of low-priority data and continues to prevent enqueuing of low-priority data (block 418) until the V_{TOTAL} once again falls to V_{LOW}, at which point enqueuing of low-priority data is resumed again.

With this approach, the adaptive flow control process described herein balances overall data throughput with responsiveness to high-priority data through selective enqueuing of low-priority data based on monitoring of criteria relative to current input queue fullness and current data padding statistics, and the dynamic modification of such criteria in view of current uplink characteristics.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method at a first wireless device, comprising:
enqueuing high-priority data into an input queue;
selectively enqueuing low-priority data into the input queue based on a current volume of data in the input queue, wherein selectively enqueuing the low-priority data includes:
initiating enqueuing of low-priority data into the input queue responsive to the current volume of data meeting a first criteria; and
ceasing enqueuing of low-priority data into the input queue responsive to the current volume of data meeting a second criteria; and
dequeuing data from the input queue for application of one or more pre-transmission processes prior to wirelessly transmitting the dequeued data for receipt by a second wireless device.

2. The method of claim 1, wherein the first criteria includes the current volume of data falling to a first threshold.

3. The method of claim 2, wherein the second criteria includes the current volume of data rising to a second threshold, the second threshold greater than the first threshold.

4. The method of claim 3, further comprising:
determining a current efficiency of data transmission from the first wireless device to the second wireless device; and
dynamically adjusting at least one of the first threshold or the second threshold based on the current efficiency.

5. The method of claim 4, wherein determining the current efficiency of data transmission includes monitoring a use of padding in the data transmission from the first wireless device to the second wireless device.

6. The method of claim 5, wherein:
monitoring a use of padding in the data transmission includes determining a current padding ratio representing a ratio of transmission padding to total uplink data; and
dynamically adjusting at least one of the first threshold or the second threshold includes:
increasing at least one of the first threshold or the second threshold when the current padding ratio meets a third criteria; and
decreasing at least one of the first threshold or the second threshold when the current padding ratio meets a fourth criteria.

7. The method of claim 6, wherein:
the third criteria includes the current padding ratio being at or below a minimum padding threshold; and
the fourth criteria includes the current padding ratio being at or above a target padding threshold.

8. The method of claim 6 or 7, wherein at least one of:
increasing at least one of the first threshold or the second threshold includes increasing at least one of the first threshold or the second threshold by a preset amount; or
decreasing at least one of the first threshold or the second threshold includes decreasing at least one of the first threshold or the second threshold by a preset amount.

9. The method of claim 1, wherein the second criteria includes the current volume of data rising to a threshold.

10. The method of claim 1, wherein:
the high-priority data includes at least one of acknowledgement packets, Domain Name Service (DNS) data, or Internet Control Message Protocol (ICMP) data; and
the one or more pre-transmission processes include at least a Packet Data Convergence Protocol (PDCP) process.

11. The method of claim 1, further comprising:
buffering low-priority data in a low-priority queue prior to enqueuing the low-priority data into the input queue.

12. (canceled)

13. A wireless device comprising:
an antenna array;
a radio frequency (RF) transceiver coupled to the antenna array; and
a modem coupled to the RF transceiver, the modem configured to:
enqueue high-priority data into an input queue;
selectively enqueue low-priority data into the input queue based on a current volume of data in the input queue by:
initiating enqueuing of low-priority data into the input queue responsive to the current volume of data meeting a first criteria; and
ceasing enqueuing of low-priority data into the input queue responsive to the current volume of data meeting a second criteria; and
dequeue data from the input queue for application of one or more pre-transmission processes prior to wirelessly transmitting the dequeued data for receipt by another wireless device.

14. The wireless device of claim 13, wherein the wireless device is a user equipment (UE) of a cellular network.

15. (canceled)

16. The wireless device of claim 13, wherein:
the first criteria includes the current volume of data falling to a first threshold; and
the second criteria includes the current volume of data rising to a second threshold, the second threshold greater than the first threshold.

17. The wireless device of claim 16, wherein the modem is further configured to:
determine a current efficiency of data transmission from the wireless device to the other wireless device; and
dynamically adjust at least one of the first threshold or the second threshold based on the current efficiency.

18. The wireless device of claim 17, wherein the modem is configured to determine the current efficiency of data transmission by monitoring a use of padding in the data transmission from the wireless device to the other wireless device.

19. The wireless device of claim 18, wherein:
the modem is configured to monitor a use of padding in the data transmission by determining a current padding ratio representing a ratio of transmission padding to total uplink data; and
the modem is configured to dynamically adjust at least one of the first threshold or the second threshold by:
increasing at least one of the first threshold or the second threshold when the current padding ratio meets a third criteria; and
decreasing at least one of the first threshold or the second threshold when the current padding ratio meets a fourth criteria.

20. The wireless device of claim 19, wherein:
the third criteria includes the current padding ratio being at or below a minimum padding threshold; and
the fourth criteria includes the current padding ratio being at or above a target padding threshold.

21. The wireless device of claim 13, wherein the second criteria includes the current volume of data rising to a threshold.

22. The wireless device of claim 13, wherein:
the high-priority data includes at least one of acknowledgement packets, Domain Name Service (DNS) data, or Internet Control Message Protocol (ICMP) data; and
the one or more pre-transmission processes include at least a Packet Data Convergence Protocol (PDCP) process.
